(19) United States
(12) Patent Application Publication
(10) Pub. No.: US 2002/0011170 A1
(43) Pub. Date: Jan. 31, 2002

(54) Printers and printing method

(76) Inventors: Akitomo Kuwabara, Hitachinaka (JP); Shuho Yokokawa, Hitachinaka (JP); Isao Nakajima, Hitachinaka (JP); Katsumi Ishizawa, Hitachinaka (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/915,380

(22) Filed: Jul. 27, 2001

(30) Foreign Application Priority Data
Jul. 28, 2000 (JP) 2000-228128

(51) Int. Cl. B41F 1/54

(52) U.S. Cl. 101/484; 400/579

(57) ABSTRACT

A printer characterized in that it has a web handling unit comprising a web conditioning means (4) for providing fixed control of the moisture within the web being fed, a skew correction means (10) for adjusting the traveling position of the web which has been passed through the web conditioning means, and a tension assigning means (8) for assigning fixed tension to the web, and an image forming means (12) that forms an image on the web sent from the web handling unit.

### BACKGROUND OF THE INVENTION

1. Field of the Invention

The present invention relates to printers and a printing method, particularly to those which form images on the webs fed at high speed.

2. Related Background Art

In the general types of printers that form images on webs, the pin members of the tractor mechanism mounted on the printer are engaged with the feed holes of the web and the tractor mechanism is driven to feed the web and form an image thereon using the image forming section of the printer. After the web with the feed holes has been printed, however, these feed holes (usually, the left and right edges of the web) need to be cut and thus a time is spent in obtaining the final printed matter. Also, the printer itself requires a tractor mechanism as its mandatory component, and absolutely needs to take a complex configuration. Such cutting operation as mentioned above can be omitted by adopting webs free of feed holes, using a tractor mechanism, instead of the web feeder of the printer, and providing a web feed roller mechanism.

By the way, for a printer that uses webs free of feed holes and forms an image on a web while feeding it by use of a feed roller mechanism, if this printer is of the type up to a middle-speed region in which only about 50 pages per minute can be printed on an A4-paper horizontal feed basis, printing not conspicuous in terms of print position offsets is possible since not too significant slipping occurs between the web and the feed rollers. If, however, the printer is of the high-speed region type capable of printing more than 100 pages per minute or is of the ultrahigh-speed region type capable of printing more than 200 pages per minute, it is difficult under the conventional configuration to feed the web to the image forming section accurately and the need arises to control the tension, traveling position, moisture, etc. of the web being fed.

### SUMMARY OF THE INVENTION

The primary object of the invention is to provide a printer and printing method that enables stable feed of webs at high accuracy by maintaining almost constant web status, irrespective of the web type, prior to feeding the web to the image forming means of the printer. The secondary object of the invention is to obtain a printer by which the image formed on the web fed at high speed can be fixed or dried using a compact heating means.

The objects set forth above can be achieved by obtaining a printer having

a web handling unit comprising a web conditioning means for providing fixed control of the moisture within the web being fed, a skew correction means for adjusting the traveling position of the web which has been passed through said web conditioning means, and a tension assigning means for assigning fixed tension to the web,

and an image forming means that forms an image on the web sent from said web handling unit.

### BRIEF DESCRIPTION OF THE DRAWINGS

FIG. 1 is a total block diagram of the printer shown as an embodiment of the present invention.

FIG. 2 is a diagonal view of the web conditioning means.

FIG. 3 is a cross-sectional view of the suction box constituting the web conditioning means.

FIG. 4 is a control block diagram of the heater element.

### DETAILED DESCRIPTION OF PREFERRED EMBODIMENTS

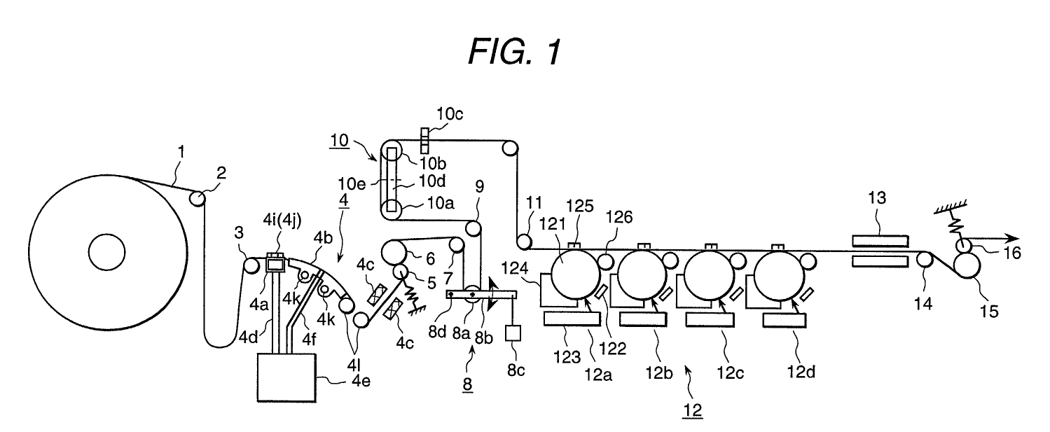

Embodiments of the present invention are described below using drawings. FIG. 1 is a schematic diagram showing an embodiment of the printer pertaining to the present invention.

Numeral 1 in FIG. 1 denotes a web. Web 1 is made from paper, a plastic film, or the like, and the configuration applied when a web wound into roll form is used is shown in this embodiment. Web 1 is inducted into web conditioning means 4 via guide rollers 2 and 3 arranged on the web feed route.

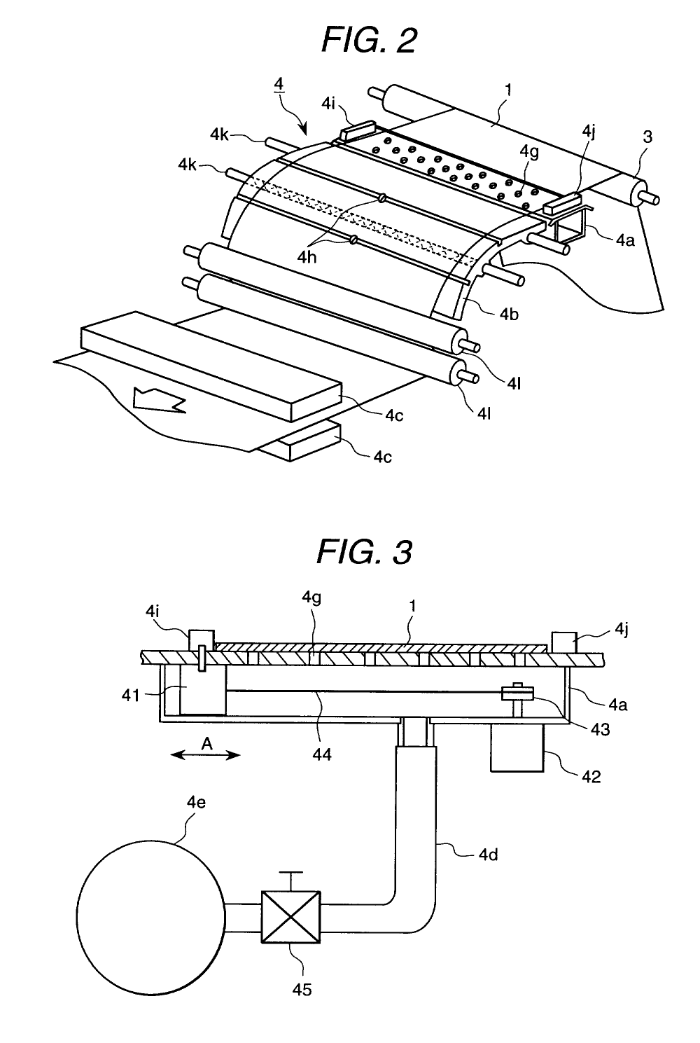

Conditioning means 4 is equipped with a suction box 4a, a suction heater 4b, and web coolers 4c. In this configuration, the suction box 4a is connected to a blower 4e via a duct 4b, and similarly, the suction heater 4b is connected to the blower 4e via a duct 4f. And since, as shown in FIG. 2, through-holes 4g and 4h for suction are formed on the surfaces of the suction box 4a and the suction heater 4b, respectively, when the blower 4e is operated and suction force is generated, the suction force is assigned to the surfaces of the suction box 4a and the suction heater 4b by the passage of web 1 along the surfaces of the suction box and the suction heater. The suction force here is preset to such a relatively low pressure as to enable web guides 4i and 4j on the suction box 4a to adjust the traveling position of web 1 when it is passed between the web guides 4i and 4j.

Also, the suction heater 4b has a heater element 4k including a heater lamp, a sheathed heater, etc., and is constructed so that when the heater element 4k is operated, the surface of the suction 4b is heated to the required temperature.

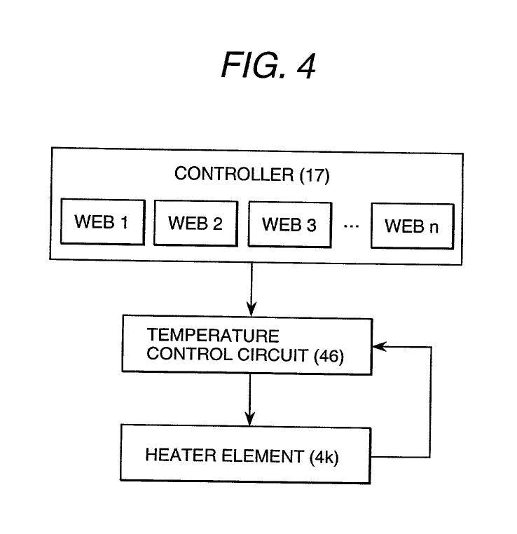

Under this configuration, data that has been obtained from experiments (data on the width of the web, on the ream weight, and on moisture content) is stored within the controller 17 shown in FIG. 4, and when “Web 1” is selected, power will be supplied to heater element 4k under, for example, heating conditions suitable for a thin web, and thus the surface temperature of suction heater 4b will be controlled, and when “Web 2” is selected, the heating conditions will be changed to those suitable for a web slightly thicker than in the case of “Web 1”, and then power will be supplied to heater element 4k to control the surface temperature of suction heater 4b. Near the surface of suction heater 4b is provided a temperature sensor (not shown in the figure), whose output signal is used to provide feedback control in order to maintain the surface temperature of suction heater 4b at a fixed value.

Any web type from “Web 1” to “Web n” is manually switch-selectable by the operator or is automatically selectable in accordance with the output signal of a measuring instrument which can measure the thickness of the web on its delivery route.

Furthermore, the method of selection of heating conditions does not always need to be limited to step-by-step selection from “Web 1” to “Web n”. Instead, power to heater element 4k can be controlled more precisely in accordance with the output signal of a humidity measuring instrument provided upstream in the feed direction of the web with respect to suction heater 4b.

In addition, it is preferable that at least either the web guide 4i or 4j on the suction box 4a should be provided so as to be movable according to the particular width of the web. In this embodiment, as shown in FIG. 3, the web guide 4j is fixed and the web guide 4i is provided so that it can be moved both forward and backward with respect to the web guide 4j as denoted by arrow A. The moving mechanism for the web guide 4i can have this web guide fixed to, for example, a shutter member 41 provided inside the suction box 4a. The shutter member 41 opens or closes the through-holes 4g, depending on the particular width of the web, and is provided as a suction area adjusting member inside the suction box 4a, and a motor 42 that can be rotated both forward and backward drives a pulley 43. Thus, the shutter member 41 connected to a wire 44 is moved in the direction of arrow A and the web guide 4i is moved in synchronization with the movement of the shutter member.

Numeral 45 in FIG. 3 denotes a valve for regulating the flow rate of the air sent from the blower 4e, and this valve controls the flow rate of the air to the optimum value according to the particular width and ream weight of the web.

In addition to having its traveling position adjusted during passage along the surfaces of the suction box 4a and the suction heater 4b, web 1 has its internal moisture evaporated to the required level by heating. After web 1 has been pulled out from the suction heater 4b, fixed tension is assigned to the web during passage along the route constructed so that the web is taken up by a plurality of guide rollers 41 (in this embodiment, two pieces). Hot web 1 is then cooled to almost room temperature by coolers 4c provided at the immediately succeeding stage, and is fed onto feed rollers 5 and 6.

The web 1 fed in S-form wound form from the feed rollers 5 and 6 is inducted into a dancer roller mechanism 8 via a guide roller 7. The dancer roller mechanism 8 is for assigning fixed tension to the web 1 fed, and consists of a dancer roller 8a, an arm 8b for supporting the dancer roller 8a, and a weight 8c. The arm 8b here is provided so that it can be oscillated in the direction of the arrow around a shaft 8d and so that when the arm 8b is oscillated, the dancer roller 8a moves vertically in synchronization with the oscillation. The weight 8c is provided at the free end of the arm 8d (instead of using the weight, a spring can also be provided in strapped form between the free end of the arm 8d and a fixed portion such as a frame).

After being passed through the dancer roller mechanism 8, web 1 is fed to a skew correction mechanism 10 via a guide roller 9. The skew correction mechanism 10 consists of two rollers provided in parallel for position restriction, and a sensor 10c for detecting the edges of the web 1 fed. The position restriction rollers 10a and 10b are rotatably supported by frame 10d under their parallel maintained status, and these rollers are constructed so that both can be rotationally moved at the same time by rotating the frame 10d round the shaft 10e. The amount of rotation of the frame 10d supporting the position restriction rollers 10a and 10b is controlled according to the particular output from the sensor 10c.

The web 1 that has been passed through the skew correction mechanism 10 is fed to an image forming section 12 via a guide roller 11. The present invention does not limit the structure of the image forming section 12. In this embodiment, however, an image forming section is exemplified that takes a configuration in which a toner image is formed on a photosensitive material using a known electrophotographic process, and the embodiment shows structure in which a color image is formed on one side of web 1 by four imaging portions, 12a, 12b, 12c, and 12d.

The structure of the imaging portions is described below taking imaging portion 12a as an example. Numeral 121 in the figure denotes a photosensitive material roller. When the photosensitive material roller 121 starts rotating, a high voltage is applied to a corona charger 122 and the surface of the photosensitive material roller 121 is uniformly charged. The laser beam that has been emitted from a light source 123 including a semiconductor laser, photo-emitting diodes, etc., provides the surface of the photosensitive material roller 121 with image exposure and forms an electrostatic latent image on the roller 121. When the photosensitive material roller area holding this latent image reaches a position that faces an image developing unit 124, a developing agent is supplied to the electrostatic latent image and a toner image is formed on the photosensitive material roller 121. The toner image that has been formed on the photosensitive material roller 121 is attracted onto web 1 by the action of a transfer unit 125 by which a charge of opposite polarity to that of the toner image is assigned to the reverse side of web 1. The area that has passed the transfer position of the photosensitive material roller 121 is cleaned by a cleaning unit 126 in order to prepare for the next printing operation.

After, in the way described above, the toner image has been transferred from the four imaging portions, 12a, 12b, 12c, and 12d, to web 1, the toner image is fixed by the passage of the web through a heater 13 and the web is unloaded from the printer via guide rollers 14, 15, and 16. After this, the web is carried to a post-processor (not shown in the figure), where the printer then performs the required processes, such as cutting, stapling, and punching, on the web to complete the series of operations.

Although the description made above assumes a configuration in which four imaging portions are arranged in line on one side of the web, four more imaging portions can also be arranged on the other side of the web to apply the present invention to a printer capable of forming color images on both sides of the web.

In addition, the application of the imaging portions is not limited to electrophotographic processes, and these portions can use ink jet recording or is applicable to impact recording that uses an ink ribbon and a printing hammer, or to other known recording schemes. In the case of electrophotographic processes, the heater 13 functions as a toner image fixing unit. In the case of ink jet recording, however, this heater can be used as a means of drying the ink recorded on the web.

Furthermore, the applicable web type is not limited to a roll-wound type, and a web of the type which is folded in zigzag form along seams can also be used.

As set forth above, according to the present invention, it is possible to provide a printer and printing method that enables stable feed of webs at high accuracy by maintaining almost constant web status, irrespective of the web type, prior to feeding the web to the image forming means of the printer. It is also possible to obtain a printer and printing method by which, since any extra moisture contained in the web is removed by the web conditioning means prior to the formation of an image, the thermal load on the heating means located at the stage succeeding the image forming means can be reduced and the image formed on the web fed at high speed can be fixed or dried using a compact heating means.

What is claimed is:

1. 1. A printer characterized in that it has
a web handling unit comprising a web conditioning means for providing fixed control of the moisture within the web being fed, a skew correction means for adjusting the traveling position of the web which has been passed through said web conditioning means, and a tension assigning means for assigning fixed tension to the web,
and an image forming means that forms an image on the web sent from said web handling unit.

2. A printer as set forth in claim 1 above, wherein said web conditioning means is characterized in that it comprises a suction heating means, which uses suction to heat said web, and a cooling means, which cools the web passed through said suction heating means.

3. A printer as set forth in claim 1 above, wherein said skew correction means is characterized in that it comprises a means for detecting the left and right edges of the web passed through said web conditioning means, and a movable roller mechanism for providing the traveling position of the web with correction based on the output from said detection means.

4. A printer having
a web handling unit comprising a web conditioning means for providing fixed control of the moisture within the web being fed, a skew correction means for adjusting the traveling position of the web which has been passed through said web conditioning means, and a tension assigning means provided on the web feed route between said web conditioning means and said skew correction means in order to assign fixed tension to the web, and an image forming means that forms an image on the web passed through the skew correction means,
wherein said printer is characterized in that the tension acting on the web passed through the web conditioning means is defined as such low tension as to make it relatively easy for the web to move, and in that the tension acting on the web passed through said image forming means is defined as tension higher than that applied to the web passed through the web conditioning means.

5. A printer as set forth in claim 1 or 4 above, wherein said image forming means comprises a plurality of image forming portions arranged in the feed direction of the web, and a unit for heating the image that has been formed on the web by said image forming portions.

6. A printing method characterized in that it comprises
a web conditioning process in which, before an image is formed on the web fed, the moisture within the web is controlled for a fixed value, a tension assigning process in which fixed tension is applied to the web, and a skew correction process in which the traveling position of the web is adjusted.

7. A printing method as set forth in claim 6 above, wherein said web conditioning process is characterized in that it further included a suction heating process that uses suction to heat said web, and a cooling process performed to cool the web that has undergone said suction heating process.

8. A printing method as set forth in claim 6 above, wherein said skew correction process is characterized in that it further includes a process for detecting the left and right edges of the web and a process for rotationally actuating said movable roller mechanism according to the data obtained in said detection process and thus correcting the traveling position of the web.

9. A printing method comprising
a web conditioning process in which, before an image is formed on the web fed, the moisture within the web is controlled for a fixed value, a tension assigning process in which fixed tension is applied to the web, and a skew correction process in which the traveling position of the web is adjusted,
wherein said printing method is characterized in that the tension acting on the web during said web conditioning process is defined as such low tension as to make it relatively easy for the web to move, and in that the tension acting on the web during said image forming process is defined as tension higher than that applied during the web conditioning process.

10. A web printer characterized in that it has
a web handling unit which comprises a web conditioning means for reducing the content of moisture in the web delivered, a skew correction means for adjusting the traveling position of said web after it has moved past said web conditioning means, and a tension assigning means for assigning fixed tension to the web,
and an image forming means that forms an image on the web delivered from said web handling unit.

11. A web printer as set forth in claim 10 above, wherein the printer is characterized in that said image forming means comprises
a plurality of image forming portions arranged along the feed direction of the web, and
a heating unit for heating the image that was formed on the web by said image forming means.

12. A printing method characterized in that it comprises
a web conditioning process in which the content of moisture in the web to be delivered is reduced prior to the formation of an image on said web,
a tension assigning process in which fixed tension is assigned to the web, and
a skew correction process in which the traveling position of the web is corrected.
